(19) United States
(12) Patent Application Publication
(10) Pub. No.: US 2025/0135758 A1
(43) Pub. Date: May 1, 2025

(54) COSMETICS BAG, WATER-RESISTANT MATERIAL FOR SUCH, AND METHOD OF MANUFACTURE THEREOF

(71) Applicant: Refy Beauty Ltd, Manchester (GB)

(72) Inventors: Jenna Meek, Manchester (GB); Danielle Nichol, Manchester (GB); Sophia Manley, Manchester (GB); Megan Barker, Manchester (GB); Daniel Wu, Manchester (GB)

(21) Appl. No.: 18/932,555

(22) Filed: Oct. 30, 2024

(30) Foreign Application Priority Data
Oct. 31, 2023 (GB) 2316704.2
Nov. 2, 2023 (GB) 2316832.1

(51) Int. Cl. B32B 27/12; A45C 11/00; B32B 5/02; B32B 7/12; B32B 27/08; B32B 27/36; B32B 27/40; B32B 37/12; B32B 37/18

(52) U.S. Cl. CPC B32B 27/12; A45C 11/008; B32B 5/024; B32B 7/12; B32B 27/08; B32B 27/36; B32B 27/40; B32B 37/12; B32B 37/182; B32B 2262/062; B32B 2274/00; B32B 2305/188; B32B 2307/7265; B32B 2439/06

(57) ABSTRACT

A bag for storing cosmetic products comprising an outer surface and an inner surface, wherein the inner surface comprises a cotton textile having a water-resistant coating, wherein the water-resistant coating comprises a thermoplastic polyurethane, TPU, membrane. A method of manufacture is also provided comprising obtaining a cotton textile, bonding a water-resistant membrane to a surface of the cotton textile, wherein the water-resistant membrane comprises thermoplastic polyurethane, TUP, and polyethylene terephthalate, PET; and manufacturing a bag using the water-resistant material, wherein the bag comprises an inner surface, and wherein the water-resistant layer is arranged on the inner surface of the bag.

### FIELD OF THE INVENTION

The present disclosure relates to a bag for storing cosmetic products and makeup, a water-resistant material for such a bag, and method of manufacture of such.

### BACKGROUND

Durability of textile products, in particular textile bags, can be problematic as textiles are prone to staining due to their absorbent nature.

Bags can also be difficult to clean as, unlike most garments, many bags are not suitable for washing machine use. However, even machine washing can often fail to remove stains from textile bags. As such, staining often causes bags to be prematurely discarded by users, increasing waste, and reducing the usable life of the bag.

To improve durability of the outer surface of bags, waterproofing or water-resistant fabric treatments may be applied to the outer surface. However, these treatments commonly alter the textile properties, including the flexibility, appearance, and feel of the textile.

Inner linings of bags are also prone to staining. This issue is compounded by the common requirement for a bag lining to be a lightweight and flexible textile. As such, common waterproofing or water-resistant fabric treatments are unsuitable for inner bag linings and are not used.

The inner surface (or inner lining) of makeup bags are particularly prone to staining due to their intended purpose of storing pigmented make up and cosmetic products. The current solution to this problem often relies on the use of dark lining fabrics simply to minimise the visibility of such stains.

There is therefore a need to improve the durability and washability of bags, in particular for bag inner lining textiles, to reduce staining and increase the useable life of bags.

### SUMMARY OF THE INVENTION

Aspects of the invention are as set out in the independent claims and optional features are set out in the dependent claims. Aspects of the invention may be provided in conjunction with each other and features of one aspect may be applied to other aspects.

In a first aspect of the invention, there is provided a bag for storing cosmetic products comprising an outer surface and an inner surface, wherein the inner surface comprises a cotton textile having a water-resistant coating, and wherein the water-resistant coating comprises a thermoplastic polyurethane, TPU, membrane. This may be particularly advantageous as the inner linings of bags, in particular bags for storing cosmetic products, are prone to staining. In addition, the present invention provides an alternative to common waterproofing or water-resistant fabric treatments which are often unsuitable for inner bag linings and are not used, not least because of the common requirement for a bag lining to be a lightweight and flexible textile.

The bag may be a makeup bag or a cosmetics bag.

The TPU membrane may have a matte surface finish. This may be advantageous to confer the required matte textile properties commonly required for lining materials. Known water-resistant treatments commonly alter the textile properties, including the flexibility, appearance, and feel of the textile, which make them unsuitable for lining fabrics. This may be particularly true of reflective, glossy, and/or high-shine coatings.

The TPU membrane may comprise a polyethylene terephthalate, PET, surface layer. This may be advantageous as the applicant has surprisingly found that a PET surface layer may improve the wipe-clean, water-resistant properties of a TPU membrane. In addition, the PET surface layer may advantageously confer a matte surface finish to a TPU membrane.

The cotton textile may have a thread count of over 20. The applicant has surprisingly found that the combination of a cotton textile comprising a thread count of over 20 and a TPU membrane results in enhanced wipe-clean material performance, and improves durability of the textile. More preferably, the cotton textile may have a thread count of over 50.

The textile layer of the inner surface may be a white cotton textile. The present invention may advantageously facilitate the use of white or light-coloured lining textiles which were previously not feasible for use as lining materials due to their propensity to stain and discolour.

The bag may further comprise a thermoplastic polyurethane, TPU, membrane on the outer surface of the bag, optionally wherein the TPU membrane further comprises a PET layer. This may additionally be advantageous to reduce staining and improve washability and durability of the bag outer surface as well.

In another aspect of the invention, there is also provided a method of manufacturing a water-resistant material, the method comprising: obtaining a cotton textile; and bonding a water-resistant membrane to a surface of the cotton textile, wherein the water-resistant membrane comprises thermoplastic polyurethane, TPU, and polyethylene terephthalate, PET. This may be advantageous as the applicant has surprisingly found that a PET surface layer may improve the wipe-clean, water-resistant properties of a TPU membrane. In addition, the PET surface layer may advantageously confer a matte surface finish to a TPU membrane.

The water-resistant membrane may comprise a laminate comprising a TPU base layer and a PET surface layer.

The cotton textile may have a thread count of over 20. The applicant has surprisingly found that the combination of a cotton textile comprising a thread count of over 20 and a TPU membrane results in enhanced wipe-clean material performance, improving durability of the textile. More preferably, the cotton textile may have a thread count of over 50.

The method may further comprise desizing the cotton textile to remove size material prior to bonding the water-resistant membrane.

The method may further comprise scouring the cotton textile at a pH between 9 and 10 to remove impurities prior to bonding the TPU membrane.

The method may further comprise bonding the water-resistant membrane to the surface comprises adhering the water-resistant membrane to the cotton textile using reactive polyurethane adhesive.

There is also provided a material manufactured according to the method the preceding aspect of the invention.

There is also provided a method of manufacturing a bag for storing cosmetic products, the method comprising: obtaining water-resistant material manufactured according to the method of the second aspect of the invention; and manufacturing a bag using the water-resistant material, wherein the bag comprises an inner surface, and wherein the water-resistant layer is arranged on the inner surface of the bag.

Obtaining the water-resistant material manufactured may additionally comprise performing the method of the second aspect of the invention.

There is also provided a bag for storing cosmetic products, the bag manufactured according to the method of the preceding aspect of the invention.

### BRIEF DESCRIPTION OF DRAWINGS

Embodiments of the disclosure will now be described, by way of example only, with reference to the accompanying drawings, in which:

FIG. 1A illustrates a front view of an embodiment of a cosmetic bag of the present invention.

FIG. 1B illustrates a top view of the cosmetic bag in an open configuration.

FIG. 1C illustrates a side view of the cosmetic bag of the present invention.

FIG. 2 shows a schematic of an example method of the present invention for manufacturing a water-resistant material.

FIG. 3A shows a photograph of a bag manufactured according to the method of the present invention prior to a cleaning test, in particular, FIG. 3A shows the outer material of the bag.

FIG. 3B shows a photograph of the bag shown in FIG. 3A after the cleaning test has been performed.

FIG. 4A shows a photograph of a bag manufactured according to the method of the present invention prior to a cleaning test, in particular, FIG. 4A shows the inner lining material of the bag.

FIG. 4B shows a photograph of the bag shown in FIG. 4A after the cleaning test has been performed.

FIG. 5A shows a photograph of an uncoated cotton canvas bag prior to a cleaning test, in particular, FIG. 5A shows the outer uncoated material of the bag.

FIG. 5B shows a photograph of the bag shown in FIG. 5A after the cleaning test has been performed.

FIG. 6A shows a photograph of an uncoated cotton canvas bag prior to a cleaning test, in particular, FIG. 6A shows the inner uncoated lining material of the bag.

FIG. 6B shows a photograph of the bag shown in FIG. 6A after the cleaning test has been performed.

FIG. 7A shows a photograph of a bag comprising a coated cotton outer material, polyester and rayon inner material prior to a cleaning test, in particular, FIG. 7A shows the outer material of the bag.

FIG. 7B shows a photograph of the bag shown in FIG. 7A after the cleaning test has been performed.

FIG. 8A shows a photograph of a bag comprising a coated cotton outer material, polyester and rayon inner material prior to a cleaning test, in particular, FIG. 8A shows the inner lining material of the bag.

FIG. 8B shows a photograph of the bag shown in FIG. 8A after the cleaning test has been performed.

FIG. 9A shows a photograph of a bag comprising a polyurethane coated outer material and synthetic inner material for this bag prior to a cleaning test, in particular, FIG. 9A shows the outer material of the bag.

FIG. 9B shows a photograph of the bag shown in FIG. 9A after the cleaning test has been performed.

FIG. 10A shows a photograph of a bag comprising a polyurethane coated outer material and synthetic inner material for this bag prior to a cleaning test, in particular, FIG. 10A shows the inner lining material of the bag.

FIG. 10B shows a photograph of the bag shown in FIG. 10A after the cleaning test has been performed.

FIG. 11A shows a photograph of a cosmetics bag comprising a TPU coated inner lining material according to the present invention after six weeks of normal use.

FIG. 11B shows a photograph of the bag shown in FIG. 11A after a cleaning test has been performed.

FIG. 12 shows a photograph of a cosmetics bag having an uncoated lining which has been machine washed after a period of normal use.

### SPECIFIC DESCRIPTION

Embodiments of the claims relate to a bag for storing makeup and cosmetic products, a water-resistant material for such a bag, and method of manufacture of such.

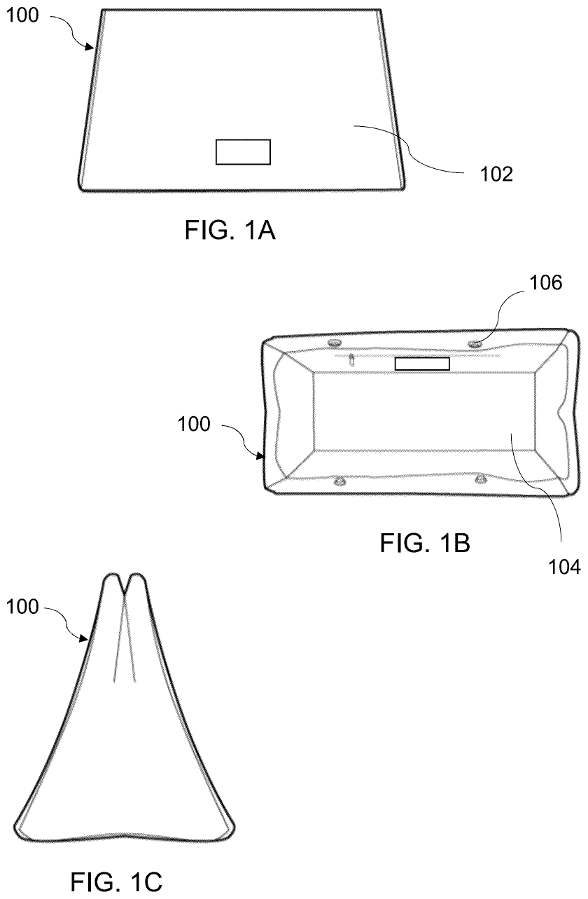

FIGS. 1A to 1C show an embodiment of a cosmetic bag 100 of the present invention. The bag 100 comprises an outer surface 102 of a first textile. In this example, the first textile comprises a cotton canvas textile. Preferably, the cotton canvas textile is 100% cotton. The first cotton canvas textile uses cotton with a yarn count of 20 which has been twisted (1800 T/cm) in order to create a more stable and durable textile with lower risk of shrinking. The first cotton canvas textile preferably also uses a 3 ply yarn. The 3 ply yarn may advantageously increase the durability of the textile, for example compared to conventional canvas textiles which typically use a yarn count of 8, and single ply The resulting cotton textile may have a fabric weight of approximately 335 gsm (grams per square meter). The combination of the high yarn count cotton and twisting of the yarn may advantageously allow the desired weight to be achieved. This may also be advantageous to provide a structured outer textile which allows the bag to substantially maintain its shape unsupported. The resulting cotton textile may also provide a high-quality finish and feel.

The bag 100 also comprises an inner surface 104 of a second textile. In this example, the second textile comprises a second cotton textile. Preferably, the cotton textile is 100% cotton. More preferably, the second textile is a poplin cotton weave. The second cotton textile uses cotton with a yarn count of 50. Providing a higher yarn count for the inner surface textile 104 compared to the outer surface textile 102 may be advantageous to provide a softer and more flexible textile for the inner lining. The resulting cotton textile may have a fabric weight of approximately 105 gsm. The second cotton textile preferably also uses a single ply yarn.

Both the first cotton canvas textile and the second cotton canvas textile also comprise a 25 water-resistant membrane comprising thermoplastic polyurethane, TUP. The laminate preferably comprises a TUP layer and a PET layer. The applicant has surprisingly found that cotton textiles with a yarn count of over 20 have improved the wipe-clean performance and water-resistant properties.

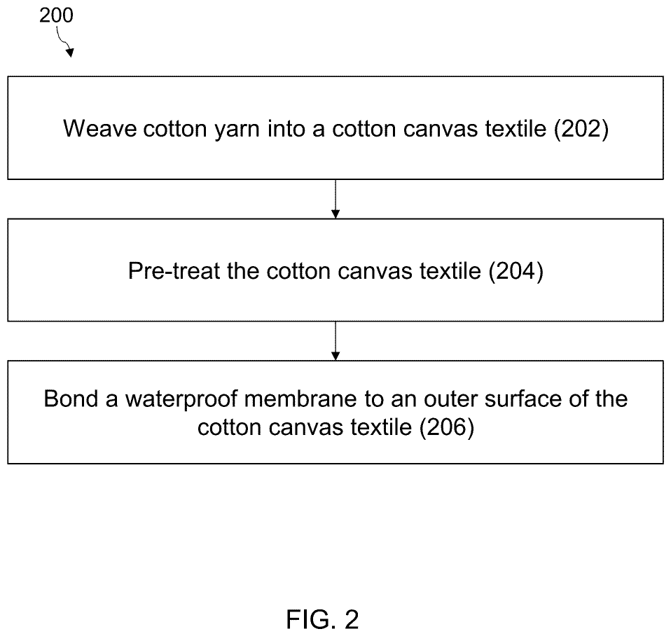

For example, each of the first cotton canvas textile and the second cotton textile may be manufactured according to the method 200 of FIG. 2.

Firstly, the method 200 comprises weaving cotton yarn into a cotton textile (202). As above, in this example, the first cotton canvas textile may be woven from cotton with a yarn count of 20 which has been twisted (1800 T/cm); whereas the second cotton textile may be woven from cotton with a yarn count of 50. Preferably, both cotton textiles are woven using an Air-Jet weaving machine.

The resultant cotton canvas textile is then subject to a sequence of pre-treatment steps (204). For example, the woven textile undergoes a desizing process to remove the size material from the warp yarns. This may be advantageous to prepare the textile for further processing. Preferably, the desizing process uses starch which avoids the use of harsh chemicals and therefore has significant environmental benefits. This may be advantageous to improve the adhesion of the waterproof TPU membrane to the cotton textile.

The textile then undergoes further pre-treatment steps, including scouring and bleaching. This may be advantageous to remove the presence of impurities such as fat, pectin, and ash in order to ensure the textile is clean. This process preferably uses a mixture of hydrogen peroxide, sodium silicate, soda ash, sodium hydroxide. This process also preferably maintains a pH between 9 and 10 for efficient cleaning during scouring process. This may be advantageous to improve the adhesion of the waterproof TPU membrane to the cotton textile.

Optionally, this is followed by dying the textile to achieve the desired colour. An advantage of embodiments of the invention is that the method of manufacturing the textile permits the use of white, cream, or light-coloured dyes and textiles by improving durability and minimise staining which is a pervasive problem with white and light-coloured fabrics, particularly in the inner linings of bags, such as cosmetics bags.

A water-resistant thermoplastic polyurethane, TPU, membrane is bonded to an outer surface of the treated cotton canvas textile (206). The use of a TPU membrane may be advantageous compared to other water-resistant or waterproofing methods because there is no need to use solvent to dissolve substances during the manufacturing process, and thus may provide significant environmental benefits.

Preferably, the TPU membrane also comprises a polyethylene terephthalate, PET, surface layer. This may further improve the water-resistant and material properties of the TPU membrane. In particular, the PET surface layer may be a matte PET layer, configured to provide a matte surface finish to the TPU membrane.

The TPU membrane is bonded to the cotton canvas textile using Reactive Polyurethane Hot-melt Adhesives (PUR). The resultant material is then laminated.

Finally, the laminated textile is then left to mature for at least one day. This may be advantageous because the Reactive Polyurethane Hot-melt Adhesives (PUR) can continue to cure based on the air humidity (moisture-curing). Thus, maturing the textile for at least a day may improve the adhesion of the TPU membrane to the cotton textile, and improve the water-resistant properties of the resulting laminated textile.

Returning to the bag 100 shown in FIGS. 1A to 1C, the inner surface of the bag 100 also comprises fastening means 106 configured to reversibly secure the opening of the bag 100 in an open configuration and a closed configuration. In this example, the securing means 106 may be a plurality of mechanical fasteners, such as snap fasteners, or magnetic fasteners. However, the skilled person will understand that any other fastening means may be used, such as a zip.

Embodiments of the bag described herein may have improved durability and washability compared to conventional bags, in particular owing to superior textiles used for the bag's exterior and inner lining to reduce staining and increase the useable life of the bag.

Experimental testing was performed to compare the washability and resistance to staining of a bag according to the present invention compared to existing bags on the market.

During testing, the outer material and inner material of each bag was soiled with four 30 different cosmetic products: (i) REFY cream bronzer (main ingredient: Ethylhexyl Palmitate), (ii) REFY gloss highlighter (main ingredient: Hydrogenated Polydecene), (iii) REFY brow pencil (main ingredient: Synthetic Wax), and (iv) REFY brow pomade (main ingredient: Cyclopentasiloxane).

The outer material and inner material of each bag then underwent a cleaning test. The cleaning test comprised manually wiping the surface of each material with a damp microfibre cloth, soaked with water. No chemical solvents, cleaning fluids, or surfactants were used. The surface of each material was wiped for approximately 30 seconds.

The resulting experimental data has been included below, including references to the Figures.

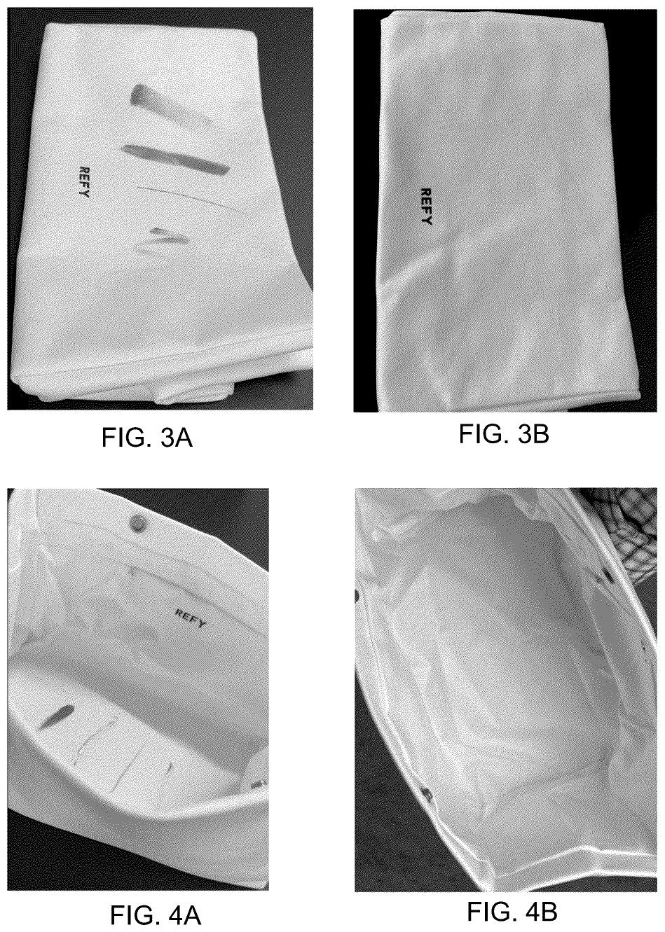

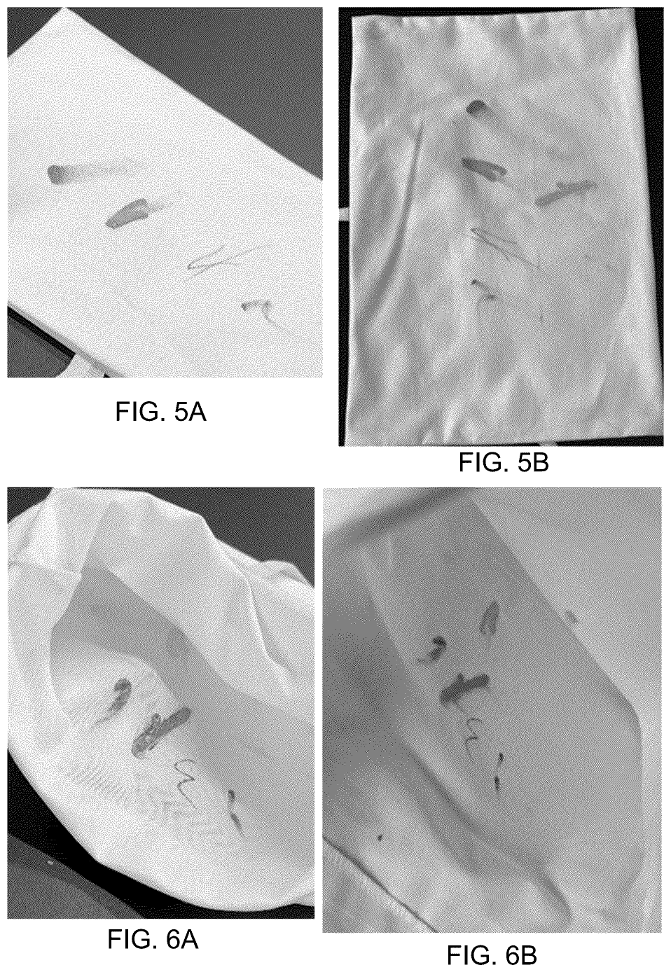

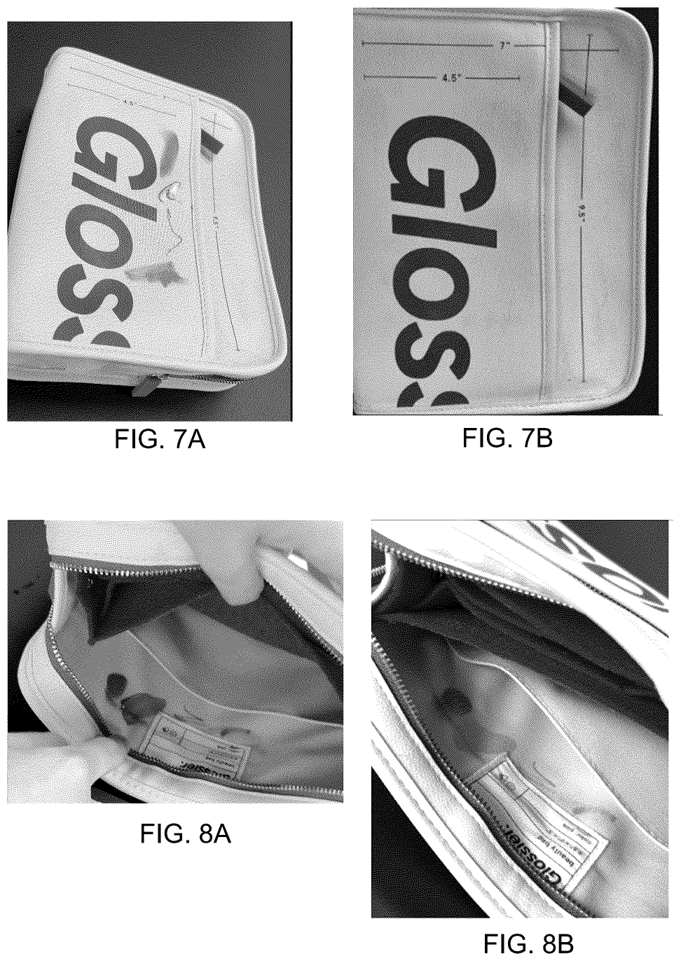

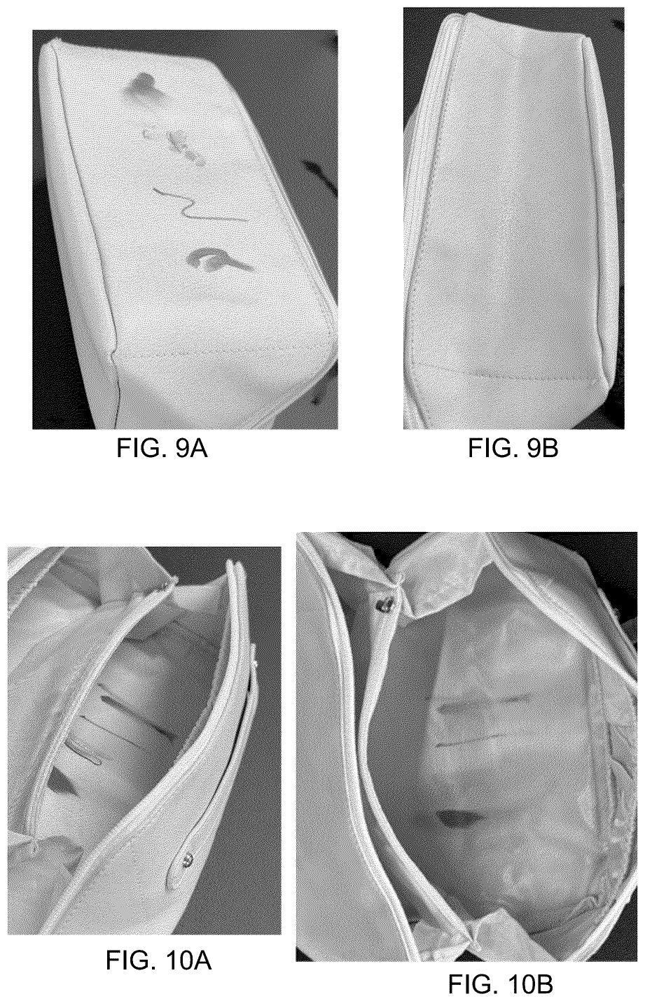

On a scale of 1 to 5, how clean was the bag outer material after wiping? 1=Unclean. 5=Clean.

| | 1 | 2 | 3 | 4 | 5 | Evidence |
|---|---|---|---|---|---|---|
| Bag 1: according to the | | | | | X | Before wiping, see |
| present invention, TPU | | | | | | FIG. 3A. |
| coated cotton canvas | | | | | | After wiping, see |
| material (outer and | | | | | | FIG. 3B. |
| inner material) | | | | | | |
| Bag 2: uncoated cotton | X | | | | | Before wiping, see |
| canvas material (outer | | | | | | FIG. 5A. |
| and inner material) | | | | | | After wiping, see |
| | | | | | | FIG. 5B. |
| Bag 3: coated cotton | | | | X | | Before wiping, see |
| outer material, polyester | | | | | | FIG. 7A. |
| and rayon inner material. | | | | | | After wiping, see |
| | | | | | | FIG. 7B. |
| Bag 4: polyurethane | | X | | | | Before wiping, see |
| coated outer material, | | | | | | FIG. 9A. |
| synthetic inner material. | | | | | | After wiping, see |
| | | | | | | FIG. 9B. |

On a scale of 1 to 5, how clean was the bag inner material after wiping? 1=Unclean. 5=Clean.

| | 1 | 2 | 3 | 4 | 5 | Evidence |
|---|---|---|---|---|---|---|
| Bag 1: according to the | | | | | X | Before wiping, see FIG. 4A. |
| present invention, TPU | | | | | | After wiping, see FIG. 4B. |
| coated cotton canvas | | | | | | |
| material (outer and inner | | | | | | |
| material). | | | | | | |
| Bag 2: uncoated cotton | X | | | | | Before wiping, see FIG. 6A. |
| canvas material (outer | | | | | | After wiping, see FIG. 6B. |
| and inner material) | | | | | | |
| Bag 3: coated cotton | X | | | | | Before wiping, see FIG. 8A. |
| outer material, polyester | | | | | | After wiping, see FIG. 8B. |
| and rayon inner material. | | | | | | |
| Bag 4: polyurethane | X | | | | | Before wiping, see FIG. 10A. |
| outer material, synthetic | | | | | | After wiping, see FIG. 10B. |
| inner material. | | | | | | |

As demonstrated above, the provision of the TPU coated cotton canvas material of the present invention as an inner lining material significantly outperformed existing products during the wipe-clean test, demonstrating significantly improved durability, resistance to staining, and washability.

Similarly, the TPU coated cotton canvas material of the present invention also outperformed existing products as an outer material during the wipe-clean test, including outperforming the coated cotton outer material of Bag 3.

This demonstrates the superior performance of the TPU coated cotton canvas material of the present invention described herein, particularly in relation to its resistance to staining and improved wipe-clean properties. As demonstrated, the TPU coated cotton canvas material of the present invention is particularly suited for use in cosmetics bags due to its ability to resist staining and wipe-clean using only water, even when exposed to highly pigmented cosmetic products.

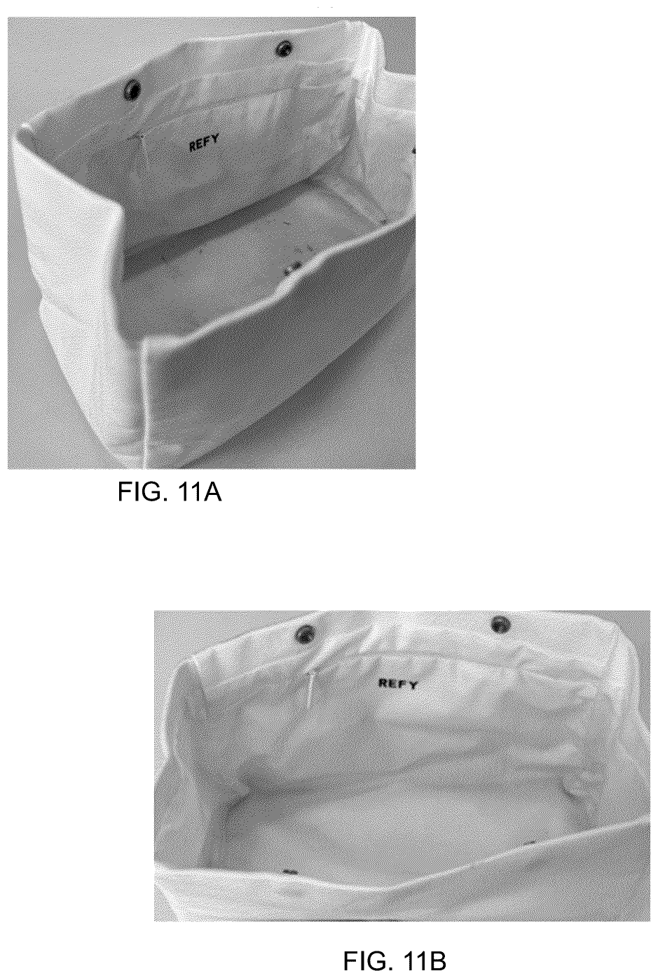

A second experimental trial was conducted whereby a user tested using the cosmetics bag of the present invention every day for six weeks. FIG. 11A shows a photograph of the bag after six weeks of normal use, storing makeup and cosmetics. The white lining material shows signs of soiling and discoloration from cosmetic products. After six weeks of use, the bag was then cleaned by manually wiping the inner surface of the bag with a damp microfibre cloth, soaked with water. No chemical solvents, cleaning fluids, or surfactants were used. FIG. 11B shows a photograph of the bag after cleaning via the wiping method. The white lining is shown to be restored, and all signs of staining and soiling have been removed.

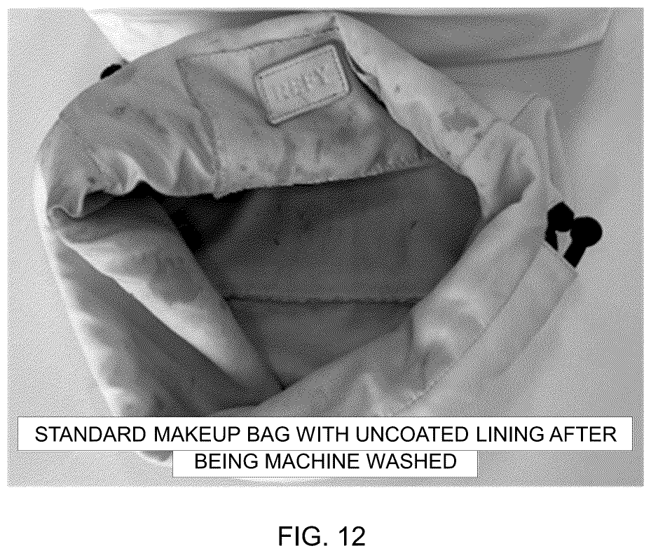

By contrast, FIG. 12 shows a photograph of a bag having an uncoated lining which has been machine washed after a period of normal use. Despite the machine washing, the white inner lining of the bag in FIG. 12 still shows significant staining and discolouration to the lining.

It will be appreciated from the discussion above that the embodiments shown in the Figures are merely exemplary, and include features which may be generalised, removed, or replaced as described herein and as set out in the claims.

In the context of the present disclosure other examples and variations of the apparatus and methods described herein will be apparent to a person of skill in the art.

1. A bag for storing cosmetic products comprising an outer surface and an inner surface, wherein the inner surface comprises a cotton textile having a water-resistant coating, wherein the water-resistant coating comprises a thermoplastic polyurethane, TPU, membrane.

2. The bag of claim 1 wherein the TPU membrane has a matte surface finish.

3. The bag of claim 1 wherein the TPU membrane comprises a polyethylene terephthalate, PET, surface layer.

4. The bag of claim 1 wherein the cotton textile has a thread count of over 20, preferably wherein the cotton textile has a thread count of over 50.

5. The bag of claim 1 wherein the textile layer of the inner surface is a white cotton textile.

6. A method of manufacturing a water-resistant material, the method comprising:
obtaining a cotton textile; and
bonding a water-resistant membrane to a surface of the cotton textile, wherein the water-resistant membrane comprises thermoplastic polyurethane, TUP, and polyethylene terephthalate, PET.

7. The method of claim 6 wherein the water-resistant membrane is a laminate comprising a TUP base layer and a PET surface layer.

8. The method of claim 6 wherein the cotton textile has a thread count of over 20, preferably wherein the cotton textile has a thread count of over 50.

9. The method of claim 6 further comprising desizing the cotton textile to remove size material prior to bonding the water-resistant membrane.

10. The method of claim 6 further comprising scouring the cotton textile at a pH between 9 and 10 to remove impurities prior to bonding the TUP membrane.

11. The method of claim 6 wherein bonding the water-resistant membrane
to the surface comprises adhering the water-resistant membrane to the cotton textile using reactive polyurethane adhesive.

12. A material manufactured according to the method of claim 6.

13. A method of manufacturing a bag for storing cosmetic products, the method comprising:
obtaining water-resistant material manufactured according to the method of claim 6; and
manufacturing a bag using the water-resistant material, wherein the bag comprises an inner surface, and wherein the water-resistant layer is arranged on the inner surface of the bag.

14. The method of claim 13 wherein obtaining the water-resistant material manufactured according to the method of claim 6 comprises performing the method of claim 6.

15. A bag for storing cosmetic products manufactured according to the method of claim 13.
